(19) United States
(12) Patent Application Publication
(10) Pub. No.: US 2020/0353931 A1
(43) Pub. Date: Nov. 12, 2020

(54) VEHICLE HAVING A WHEEL-SELECTIVE DRIVE TORQUE ASSEMBLY AND ARTICULATED JOINT, AND METHOD FOR CONTROLLING THE VEHICLE

(71) Applicant: Schaeffler Technologies AG & Co. KG, Herzogenaurach (DE)

(72) Inventors: Jürgen Römer, Zimmern ob Rottweil (DE); Philipp Kautzmann, Karlsruhe (DE); Danilo Engelmann, Durmersheim (DE)

(73) Assignee: Schaeffler Technologies AG & Co. KG, Herzogenaurach (DE)

(21) Appl. No.: 16/760,088

(22) PCT Filed: Sep. 14, 2018
(86) PCT No.: PCT/DE2018/100785

§ 371 Date: Apr. 29, 2020

(30) Foreign Application Priority Data
Nov. 8, 2017 (DE) 10 2017 126 088.9

(51) Int. Cl. B60W 30/18; B60W 10/18; B60W 40/10

(52) U.S. Cl. CPC B60W 30/18145; B60W 2510/20; B60W 40/10; B60W 10/18

(57) ABSTRACT

A vehicle is proposed having a first axle portion, wherein the first axle portion has a first axle, a second axle portion, wherein the second axle portion has a second axle, a wheel-selective drive torque arrangement, wherein at least one of the axles is designed as an axle influenced by the wheel-selective drive torque arrangement, and a control device, wherein the control device is designed to control the wheel-selective drive torque arrangement in order to convert a steering command into cornering of the vehicle, and an articulated joint, wherein the first and second axle portions are coupled to one another by the articulated joint.

### CROSS-REFERENCE TO RELATED APPLICATIONS

This application is the U.S. National Phase of PCT Appln. No. PCT/DE2018/100785 filed Sep. 14, 2018, which claims priority to DE 10 2017 126 088.9 filed Nov. 8, 2017, the entire disclosures of which are incorporated by reference herein.

### TECHNICAL FIELD

The disclosure relates to a vehicle having a first axle portion, wherein the first axle portion has a first axle, a second axle portion, wherein the second axle portion has a second axle, a wheel-selective drive torque arrangement, wherein at least one of the axles is designed as an axle which is influenced by the drive torque arrangement, and a control device, wherein the control device is designed to control the wheel-selective drive torque arrangement in order to convert a steering command into cornering of the vehicle.

### BACKGROUND

Different steering strategies are implemented in vehicles for cornering. For example, armored vehicle steering is known from military technology and is used in tracked vehicles, but also in construction equipment. The left and right wheels or tracks of the vehicle are accelerated or braked to different degrees. This enables steering by driving and/or braking. The wheels or track portions are not steered. Due to the different wheel rotational speeds or track speeds, a moment is created around the vertical axis of the vehicle, so that the vehicle turns.

The articulated steering is also known from the general prior art, wherein articulated steering vehicles consist of two vehicle parts which are connected to one another by an articulated joint device. If the vehicle is pivoted in the articulated device, the axles of the vehicle are rotated in opposite directions in order to provoke cornering. The pivoting of the articulated device is usually forced by a hydraulic force which acts on the articulated device.

From document DE 10 2015 203 201 A1, which is probably the closest prior art, a vehicle with a control circuit for controlling an actual total restoring torque in a steering system and a corresponding method are known. The basic idea of the control circuit is to influence the driver's hand torque required to drive through a curve by means of different torques on the left and on the right wheel in the sense of a steering force assistance when turning the wheels.

### SUMMARY

A vehicle has a steering strategy which can be implemented inexpensively.

A vehicle is designed in particular as a passenger car, truck, bus, etc. The vehicle is preferably designed as a four-wheeler, but in modified embodiments this can also be designed as a three-wheeler. The vehicle may also be a two-track vehicle.

The vehicle has a first axle portion and a second axle portion. The axle portions each form part of the vehicle. The vehicle is preferably formed from the two axle portions. In particular, the first axle portion forms a first vehicle half and the second axle portion forms a second vehicle half.

The first axle portion has a first axle. The first axle may have two wheels or be a two-track axle. The second axle portion has a second axle. The second axle may have two wheels or be a two-track axle. The wheels can be understood to mean single wheels, but also double or multiple wheels. The first axle and the second axle may be arranged parallel to one another. The vehicle may have exactly two axles, namely the first and the second axle.

The vehicle has a wheel-selective drive torque arrangement. At least one, exactly one or both axles are influenced by the drive torque arrangement. In the event that one of the axles is influenced by torque, this is referred to as the torque-influenced axle.

In particular, “torque-influenced” is to be understood as the influence by a positive drive torque for propulsion and by a negative drive torque for braking. In particular, “wheel-selective” is to be understood to mean that different drive torques, in particular positive and/or negative drive torques, are directed to wheels of the axle.

The drive torque arrangement can have a wheel-selective drive arrangement. The wheel-selective drive arrangement can distribute different drive torques to the wheels of an axle, so that the wheels are or may be subjected to different drive torques. In this case, the torque-influenced axle is a driven axle. In principle, it is possible for the wheel-selective drive arrangement to have a single motor for one axle, wherein the motor drive torque is distributed as the drive torque to the two wheels of the axle. In particular, it is possible to distribute the motor drive torque unevenly and/or asymmetrically. An internal combustion engine can be used as the motor, but it is preferred that one or more electric motors are used. It can also be a hydraulic drive. The wheel-selective drive torque arrangement can be designed, for example, as a central drive with a torque vectoring differential. As an alternative to this, wheel-specific motors, such as wheel hub motors, can be used as a wheel-selective drive torque arrangement. The wheel-selective drive arrangement makes traction torque available to the vehicle as the drive torque. In other words, the wheel-selective drive arrangement can implement a wheel-specific drive torque distribution. This distribution can also be referred to as torque vectoring. The wheel-selective drive arrangement can also have clutch units for the torque-influenced and/or driven axle, wherein the different drive torques is implemented by opening, slipping and/or closing the clutch units.

The drive torque arrangement can have a wheel-selective deceleration arrangement. The wheel-selective deceleration arrangement can distribute different, negative drive torques to the wheels of an axle so that the wheels are or may be subjected to different negative drive torques. The negative drive torque is in particular a braking torque. In this case, the torque-influenced axle is a braking axle. The wheel-selective deceleration arrangement can be implemented by braking of the wheels of the torque-influenced and/or braking axle. With the deceleration arrangement it is in particular possible to apply different negative drive torques to the torque-influenced and/or braking axle and/or different braking torques to the wheels.

It is also possible for the drive torque arrangement to have a wheel-selective drive arrangement and a wheel-selective deceleration arrangement. The arrangements can act on a common axle or on different axles.

The vehicle has a control device. The control device can be designed as a separate control device; alternatively, the control device can also form part of a higher-level control of the vehicle. The control device is preferably designed as a digital data processing device or comprises said device. For example, the control device is implemented as a microcontroller or the like.

The control device is designed to control the wheel-selective drive torque arrangement in order to convert a steering command into cornering of the vehicle by controlling the wheel-selective drive torque arrangement. In particular, the control device has an input interface for receiving the steering command. The input interface can be designed as a mechanical, electronic and/or data interface. Furthermore, the control device has at least one output interface, which is a data connection to the wheel-selective drive torque arrangement. Starting from the steering command, a drive torque distribution for the driven axle is determined, in particular calculated, and output to the wheel-selective drive torque arrangement via the output interface. In particular, the vehicle with the wheel-selective arrangement is steered by drive torques of different intensity, comprising positive drive torques and negative drive torques on the different axles or wheels.

It is proposed for the vehicle to have an articulated joint, wherein the first and the second axle portion is coupled to one another by the articulated joint, in particular in an articulated and/or pivotable manner. In particular, the articulated joint enables the setting of an articulation angle between the first axle portion and the second axle portion. The articulation angle in particular occurs about a vertical axis of the vehicle. The articulation angle may be set with a maximum articulation angle of at least 5°, preferably of at least 10° and in particular of at least 15°. If the first axle portion and the second axle portion are in alignment and/or the vehicle is driving straight ahead, the articulation angle is 0°.

The armored vehicle steering described at the outset has disadvantages with regard to the high load on the vehicle and on the ground. Conventional articulated steering systems, on the other hand, have the disadvantage that the articulated joint must be manipulated with an actuator, in particular a hydraulic actuator, in order to steer the vehicle. Such actuators require a large installation space in the area of the steering system so that the size and the total weight of the vehicle are increased. Furthermore, the steering energy requirement is markedly higher compared with axle steering, 3 times higher according to the literature. This is particularly important when steering in a stationary position. Another disadvantage of hydraulic external power steering for articulated steering is the high load on the frame parts of the vehicle.

On the other hand, it is proposed for the steering to take place by distributing the drive torques to the wheels of the torque-influenced axle or the torque-influenced axles. The steering force is thus generated directly from the drive train and/or the brake of the vehicle. In other words, the steering force is generated by wheel-selective influencing of the drive torques on one or more wheels. A vehicle with a steering strategy is thus proposed which combines the advantages of armored vehicle steering with the advantages of articulated steering and thereby avoids the disadvantages of the steering strategies mentioned.

The vehicle can assume a “straight ahead” operating state, wherein the vehicle moves in the longitudinal direction. The articulation angle of the articulated joint is 0° in this case. Furthermore, the vehicle can assume a “cornering” operating state, wherein the articulation angle of the articulation joint is not equal to 0°. The operating states are assumed due to corresponding control of the wheel-selective drive torque arrangement by the control device.

In principle, it is possible that the different drive torques for the wheels of the driven axle are generated by a single motor. In a possible design, however, the wheel-selective drive torque arrangement has two wheel motors on the driven axle. In particular, the wheel motors are designed as hub motors and/or direct drive motors. This design enables the steering to be implemented in a very simple manner via the wheel-selective drive arrangement.

The first axle and the second axle may each be designed as an unsteered axle. Alternatively or in addition, the first and second axles may each have a constant and/or unchangeable steering angle. The effect of the steering is therefore based on a controlled distribution or redistribution of the drive torques, not on the change in the wheel position of the wheels on the respective axle.

The articulated joint may be designed as a passive articulated joint. The steering force and/or the pivoting force is or may be generated directly from the drive torque arrangement, in particular the drive train, in particular from the wheel motors. An actuator for adjusting the articulation angle of the articulated joint can thus be dispensed with and components can be omitted.

In an alternative embodiment, the vehicle has an actuator for adjusting the articulation angle of the articulated joint, wherein the wheel-selective drive torque arrangement works as a steering force assistance.

In one possible embodiment, one of the axles is designed as the torque-influenced axle, in particular a driven axle, and the other axle is designed as a passive axle. In this embodiment, the drive train and/or the selective brake is reduced to the drive or the wheel-selective braking of the only torque-influenced axle.

In an alternative embodiment, however, both axles are designed as torque-influenced axles. Each axle can preferably be subjected to any desired drive torque, in particular positive or negative drive torque. In particular, the control device is designed to apply the desired drive torque, in particular positive or negative drive torque, to each of the wheels of the two axles.

In a method for controlling the vehicle as described above, cornering of the vehicle is initiated by different drive torques on the wheels of the torque-influenced axle, in particular the driven axle. In a development of the method, it is provided that the articulation angle of the articulated joint is changed by changing the drive torque distribution on the wheels of the at least one torque-influenced axle, in particular the driven axle.

### BRIEF DESCRIPTION OF THE DRAWINGS

Further features, advantages, and effects result from the following description of a preferred embodiment. In the figures:

FIG. 1 shows a schematic block diagram of a vehicle;

FIG. 2 shows a schematic illustration of the steering method with the vehicle from FIG. 1.

### DETAILED DESCRIPTION

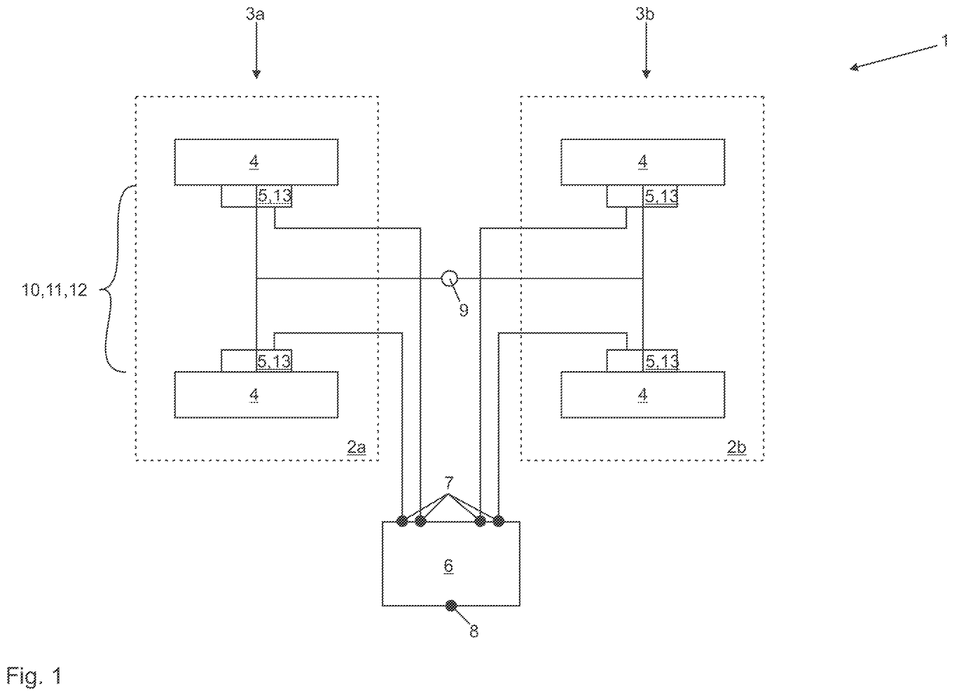

FIG. 1 shows a vehicle 1 in a schematic block diagram. The vehicle 1 has a first axle portion 2a and a second axle portion 2b. The axle portions 2a, b are arranged one behind the other in the longitudinal direction of the vehicle 1. In the exemplary embodiment shown, the axle portions 2a, b are designed as vehicle halves, in particular the vehicle 1 is divided in the middle. In alternative exemplary embodiments, the division of the vehicle 1 can also be asymmetrical. The axle portion 2a has an axle 3a, the axle portion 2b has an axle 3b. The axles 3a, 3b each have two wheels 4. The wheels 4 are arranged in the respective axle portions 2a, b, non-pivotably mounted with respect to a vertical axis of the vehicle 1. In particular, the wheels 4 are arranged rigidly and/or non-pivotably with respect to a steering angle of the wheels 4.

The wheels 4 of the first axle 3a each have a wheel motor 5, which is in particular designed as a wheel hub motor. The first axle 3a thus has two wheel motors 5 and is designed as a driven axle. In the same way, the wheels 4 of the second axle 3b are each assigned a wheel motor 5, which in particular is designed as a wheel hub motor. Optionally, in addition, the wheels 4 of the first and second axles 3a, 3b each have a brake 13. The first and second axles a, b are thus designed as torque-influenced axles. The wheel motors 5 are controlled by a control device 6 so that each wheel 5 can be selectively assigned a freely selectable drive torque. Optionally, in addition, the brakes 13 are controlled via the control device 6 so that each wheel 5 can be selectively assigned a freely selectable negative drive torque, in particular deceleration torque and/or braking torque. The wheel motors 5 together form a wheel-selective drive arrangement 10. The brakes 13 together form a wheel-selective deceleration arrangement 11. The wheel-selective drive arrangement 10 and the wheel-selective deceleration arrangement 11, together or individually, form a wheel-selective drive torque arrangement 12.

The vehicle 1 has a control device 6 for controlling the wheel motors 5 and optionally, in addition, the brakes 13 and thus the wheel-selective drive torque arrangement 12. The control device 6 is designed as a digital data processing device.

The control device 6 has an output interface 7 for data coupling with the wheel motors 5 and optionally, in addition, with the brakes 13. Furthermore, the control device 6 has an input interface 8 for receiving a steering command. Optionally, in addition, further parameters such as driving speed specification of the driver and vehicle condition variables may also be passed. For example, the input interface 8 can have a data connection to a steering wheel of the vehicle 1 for receiving the steering command.

The vehicle 1 has an articulated joint 9, via which the first and second axle portions 2a, 2b are connected to one another so as to be pivotable about the vertical axis of the vehicle 1. The articulated joint 9 is designed as a purely mechanical joint that is free of external energy and is pivoted passively. When the vehicle 1 is traveling straight ahead, an articulation angle between the first axle portion 2a and the second axle portion 2b is 0°. The pivot angle is increased when cornering.

The steering strategy of vehicle 1 is a steering system for vehicle 1 with articulated steering, the steering force for setting the articulation angle being generated by wheel-selective influencing of the drive torques on wheels 4. The steering force is thus generated directly from the drive train, namely by the wheel motors 5, and optionally, in addition, from the brakes 13.

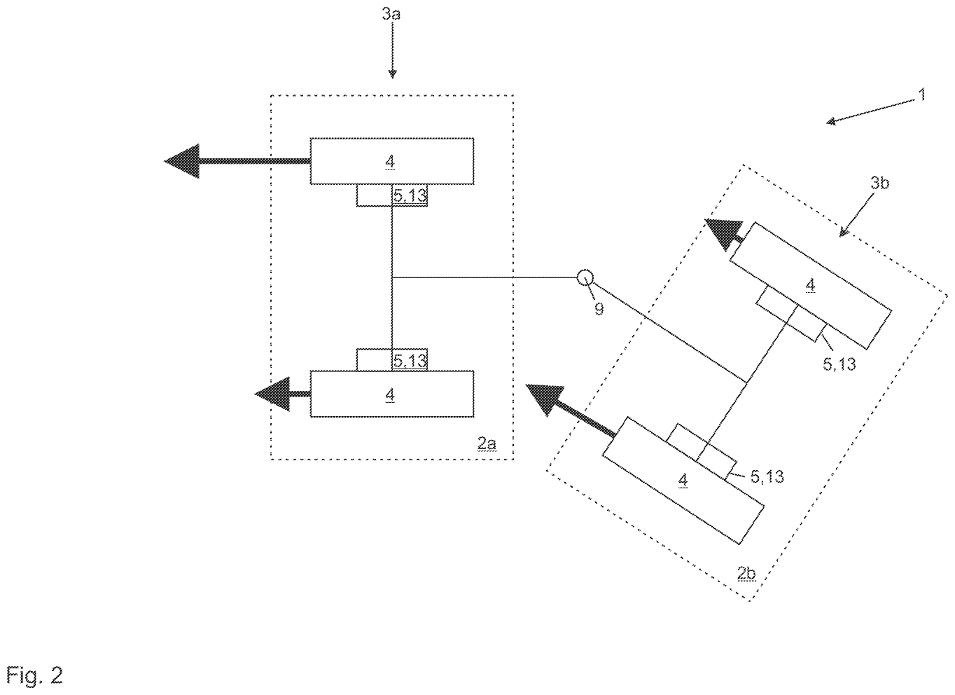

FIG. 2 shows the vehicle 1 reduced to the functional portions, the first and second axle portions 2a, 2b again being shown. The vehicle 1 is in an operating state of cornering. FIG. 2 shows the operating principle of steering of the vehicle 1 by torque vectoring and/or brake force distribution in the vehicle 1 with articulated steering. If, for example, a higher drive torque is transmitted to the left rear wheel 4, that is to say the wheel on the inside of the curve, than to the right rear wheel 4, that is to say the wheel on the outside of the curve, the second axle 3b rotates about an articulation point which is guided by the articulation joint 9. In this way, a change in the articulation angle of the articulated joint 9 is initiated via the distribution of the drive torques. As an alternative or in addition, the articulation angle can be changed if a greater drive torque is transmitted to the right front wheel 4, that is to say the wheel on the outside of the curve, than to the left front wheel 5, that is to say the wheel 5 on the inside of the curve.

The basic ideas are as follows: Conventional commercial vehicles with articulated steering (see prior art) rely on hydraulic power steering. However, there are some negative aspects associated with a hydraulic device. On the one hand, the actuator requires a large installation space in the area of the steering system and its existence also results in a higher vehicle weight. On the other hand, the steering energy requirement is higher by a factor of 3 compared with axle steering. This is particularly important when steering in a stationary position. Another disadvantage of hydraulic power steering is the high load on the frame parts.

Torque vectoring (wheel-specific torque distribution) or EPS (wheel-specific deceleration) is being used increasingly, especially in future mobile machinery. This means that a vehicle with wheel-selective drives or brakes can be steered on the various axles or wheels by means of different drive torques. Torque vectoring or braking force distribution can be used in an energy-efficient manner in conjunction with articulated vehicles. FIG. 2 shows the principle of operation of steering by torque vectoring or brake force distribution in vehicles with articulated steering. If, for example, a higher drive torque is transmitted to the left rear wheel 4 than to the right rear wheel 4, the rear axle 3b rotates about the articulation point of the articulation joint 9.

It is assumed that vehicles 1 with articulated steering can be steered completely by torque vectoring and/or brake force distribution so that the hydraulic external power steering previously required can be completely substituted. However, this requires the use of a suitable drive train, optionally a suitable deceleration arrangement, a suitable chassis and intelligent control. By using torque vectoring and/or braking force distribution in conjunction with articulated steering, there are several advantages: The greatest benefit lies in the elimination of hydraulic power steering, which can save space and weight. At the same time, the turning radius of the vehicle 1 can be significantly reduced or the maximum pivot angle reduced, which also reduces the risk of the vehicle tipping over. In addition, the so-called “jackknife effect”, i.e., the unwanted folding of the vehicle 1 can be avoided. There is also a high energy potential with torque vectoring and/or brake force distribution compared with hydraulic power steering, especially when steering in a stationary position and at lower speeds.

### LIST OF REFERENCE SYMBOLS

1 vehicle
2a, 2b axle portions
3a, 3b axles
4 wheels
5 wheel motors
6 control device
7 output interface
8 input interface
9 articulated joint
10 wheel-selective drive arrangement
11 wheel selective deceleration arrangement
12 wheel-selective drive torque arrangement
13 brakes

1. A vehicle comprising:
a first axle portion, wherein the first axle portion has a first axle,
a second axle portion, wherein the second axle portion has a second axle,
a wheel-selective drive torque arrangement, wherein at least one of the axles is designed as an axle influenced by the wheel-selective drive torque arrangement,
a control device, wherein the control device is designed to control the wheel-selective drive torque arrangement in order to convert a steering command into cornering of the vehicle, and
an articulated joint, wherein the first and the second axle portion are coupled to one another by the articulated joint.

2. The vehicle according to claim 1, wherein the vehicle can assume a “straight ahead” operating state”, wherein an articulation angle of the articulated joint is 0°, and the vehicle can assume a “cornering” operating state, wherein an articulation angle of the articulated joint is not equal to 0°.

3. The vehicle according to claim 1, wherein the drive torque arrangement has a wheel-selective drive arrangement or a wheel-selective deceleration arrangement.

4. The vehicle according to claim 3, wherein the wheel-selective drive arrangement has two wheel motors on a driven axle as the at least one torque-influenced axle or the wheel-selective deceleration arrangement has two selectively controllable brakes on a braked axle as the at least one torque-influenced axle.

5. The vehicle according to claim 1, wherein the first and second axles are designed as unsteered axles.

6. The vehicle according to claim 1, wherein the articulated joint is designed as a passive articulated joint.

7. The vehicle according to claim 1, wherein one of the axles is designed as the torque-influenced axle and the other axle is designed as a passive axle.

8. The vehicle according to claim 1, wherein both axles are designed as torque-influenced axles.

9. A method for controlling the vehicle according to claim 1, wherein cornering is implemented by introducing different drive torques onto the wheels of the at least one torque-influenced axle.

10. The method for controlling the vehicle according to claim 9, characterized in that the articulation angle of the articulation joint is changed by changing the drive torque distribution on the wheels of the at least one torque-influenced axle.

11. The vehicle of claim 7 wherein the torque-influenced axle is a rear axle.

12. A method of controlling a vehicle, the vehicle comprising:
a front axle portion having a first axle; and
a rear axle portion having a second axle and coupled to the front axle portion by an articulated joint;
the method comprising:
in response to a steering input, commanding a differential torque on one of the first axle and the second axle.

13. The method of claim 12 wherein the rear axle portion has an inside rear wheel and an outside rear wheel relative to the steering input and commanding a differential torque on one of the first axle and the second axle comprises commanding a first positive torque for the inside rear wheel and a second positive torque, less than the first positive torque for the outside rear wheel.
